(19) United States
(12) Patent Application Publication
(10) Pub. No.: US 2006/0237048 A1
(43) Pub. Date: Oct. 26, 2006

(54) Dishwasher incorporating a pump prime sensing system for managing a filtration system

(75) Inventors: David Clinton Weaver, Greenwood, MS (US); John Patrick Picardat, Greenwood, MS (US); Jerry Wayne Ferguson, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/113,520

(22) Filed: Apr. 25, 2005

(51) Int. Cl. B08B 7/04; B08B 9/20; B08B 3/00; B08B 3/04; B08B 3/12

(52) U.S. Cl. 134/56 D; 134/58 D; 134/184; 134/25.2; 134/18; 134/10; 134/104.2

(57) ABSTRACT

A pump priming sensing system for managing a filtration system is provided. The sensing system is capable of monitoring the state of the motor that operates the pump in a dishwasher to determine if the pump is receiving enough water to operate at a normal torque level. A filter is provided above the pump inlet to the pump. When a mixture of water and air is received through the pump inlet, the torque level falls. The motor transmits this decrease in torque level to a controller, which activates a filter cleaning system to clean the filter of soil/food/debris loosed from the dishes being cleaned in the dishwasher. Once the filter has been cleaned, normal operation of the dishwasher is resumed with the pump operating at a normal torque level.

### FIELD OF THE INVENTION

The present invention relates generally to a dishwasher that incorporates a pump prime sensing system for managing a filtration system.

### BACKGROUND OF THE INVENTION

Conventional domestic dishwashers utilize a drain and refill system that fills a dishwasher tub with fresh water at the beginning of the wash cycle to mix with and remove food soil from dishes. The cycle continues by drawing water through a pump that is operated by a motor and forces the water back onto the dishes through a spray arm. However, the fresh water becomes soil-laden as the food soils are removed from the dishes. The dishwashing cycle continues with the soil-laden water drawn into the pump through the pump inlet and sprayed back over the surface of the dishes. The dishwasher cycle then drains the soil-laden water from the dishwasher tub and repeats the cycle by refilling the tub with fresh water. This drain and refill sequence is typically based on a timed cycle with the draining occurring at a preset point in the overall wash cycle. This sequence repeats until the “dilution ratio” of fresh water to soil-laden water becomes high enough for the dishes to be relatively clean. However, the cleanliness of the dishes is based largely on the number of times the dishwasher drains the soil-laden water and refills the tub with fresh water. This cycling approach has several drawbacks, including expending a great amount of water, energy, and time to remove the food soil from the surface of the dishes and requiring a high-flow pressure wash system. Further, dishwashers that incorporate this cycling approach are relatively loud during drain and fill operations.

Prior dishwashers have attempted to solve some of these recycling problems by attempting to reach a high “dilution ratio” in a quieter, more consumer-friendly machine by including a filtration system. These filtration systems have helped to clean the dishes more effectively than non-filtered systems, using a minimal amount of water, and becoming vital components to help improve wash performance. However, in present dishwashers, water must pass through these filters at a high rate to keep up with the water flow demands of the main circulation pump. Present dishwashers either utilize a timing system to clean the filter at regularly timed intervals, regardless of filter impaction, or flush the filter and entire system with fresh water at certain stages in the dishwashing cycle. These timing or flushing stages generally determine the effectiveness of the dishwasher design, but limit the effectiveness of the filtration system.

In order to allow enough water to pass through the filter to meet the pump's requirements, current dishwashers include filters with large openings that allow water to pass through even if the filter is partially clogged with food or soil. These large filters fail to trap as much food as finer filters and allow more food to pass to the pump to be resprayed into the dishes.

What is needed is a filter that has as fine a screen as possible. This screen will filter the soil-laden water, but will not have such small screen openings as to clog the filter quickly. Further, present dishwashers fail to detect if a filter is clogging. Since clogging information is unavailable, filter screen holes in present dishwasher filters are larger or “coarser” and initial wash cycles have been made shorter. Although larger filter screen holes enable present dishwashers to handle large soil loads without clogging, present dishwashers suffer from reduced wash performance and efficiency.

### SUMMARY OF THE INVENTION

The present system solves the drawbacks of prior dishwashers by providing an apparatus and method for maintaining a filtration system in a dishwasher. The present system monitors the state of the motor that operates the dishwasher's pump to determine whether the pump is receiving enough water due to the filter screen becoming clogged. In order to monitor the state of the motor, variables such as power draw, torque, and speed are evaluated.

Two types of filter arrangements, full-flow and partial-flow, are available in present dishwashers. In a full-flow filter arrangement, all of the water drawn into the pump's suction inlet must first pass through the full-flow filter. In a partial-flow filter arrangement, only a portion of the water drawn into the wash pump's suction inlet first passes through the partial-flow filter. Although partial-flow filters are much less efficient than full-flow filters to sieve debris from water, the pump is not starved of water when the partial-flow filter becomes clogged. Present dishwashers typically utilize partial-flow filters.

When a full-flow filter begins to clog with debris or food soil from crockery, kitchenware, or other dishes to such a degree that the water flow rate cannot keep up with the flow rate of the pump, the water level in the sump begins to fall. The sump generally is connected to the pump's inlet and is disposed below the full-flow filter. When the water level falls a sufficient amount to allow air to enter the pump, the pump's ability or capacity to maintain its present energy state, “full prime,” will be lost. When the pump's full prime is lost, the torque load on the motor that controls the pump will fluctuate and fall to a measurably different, lower level. The present invention includes a three-phase motor with an electronic controller, which is able to detect this decline in required torque and transmit the torque and/or speed change to a microprocessor. The method of monitoring the torque load on the motor can be accomplished in numerous ways, such as are detailed in U.S. Pat. No. 5,330,588 to Whipple, III, et al., which is incorporated herein by reference in entirety.

Once the torque information is transmitted to the dishwasher's microprocessor, the microprocessor can take one of several actions to manage the situation. First, the microprocessor can instruct the dishwasher to pump the soil-laden wash water out of the dishwasher. Second, the microprocessor can instruct the dishwasher to add more water to dilute the soil-laden wash water. Third, the microprocessor can instruct the dishwasher to activate a mechanical filter-cleaning device, such as a motor-driven or mechanical wiper. Fourth, the microprocessor can instruct the dishwasher to decrease the flow rate through the pump and operate only the filter cleaning jets. Finally, the microprocessor can instruct the dishwasher to perform any combination of the above actions or any other action that will clean the filter and allow the pump to return to full prime.

The present pump prime sensing system provides a means to detect when the full-flow filter is becoming clogged. This detection means will allow the dishwasher fill water to be used more efficiently. Specifically, in a conventional dishwasher, if the full-flow filter clogs, wash action will not continue until the soil-laden water has been drained and fresh water refilled in the dishwasher tub. If the clogging occurs early in the wash cycle, the time, water, and energy already consumed by the dishwasher to refill the water would be wasted during that wash/fill.

Another advantage of the present pump prime sensing system is that the state of the full-flow filter can be monitored at all times during the cycle. Accordingly, the holes in the full-flow filter screen can be small to increase the efficiency and effectiveness of the dishwasher. The continuous monitoring of the filter screen state will enable better filter design, instead of designing the filter for a worse case soil load situation.

Another advantage of the present pump prime sensing system is that the filter cleaning method can operate to divert all of the wash water, normally sprayed on the dishes, to clean the filter. This diversion is not possible in a conventional dishwasher since conventional dishwashers are not able to provide necessary information regarding alternating between operation of the main wash system and the cleaning jets to clean the filter.

These and other objects, features, and advantages of the present invention will become more apparent upon reading the following specification in conjunction with the accompanying drawing figures.

### BRIEF DESCRIPTION OF THE DRAWINGS

FIG. 1 is a view of the dishwasher in wash mode with a clean full-flow filter.

FIG. 2 is a view of the dishwasher in wash mode with the full-flow filter becoming clogged.

FIG. 3 is a view of the dishwasher in wash mode with the full-flow filter fully clogged and air entering the pump.

### DETAILED DESCRIPTION OF THE PREFERRED EMBODIMENTS

The present pump prime sensing system is intended primarily for use with dishwashers to detect if the filtration system has become clogged with food debris. Once this information is supplied to a dishwasher's microprocessor, the dishwasher can take any of several actions, including: activating a separate filter cleaning device or system such as a mechanical wiper, activating additional filter cleaning jets to unclog the filter, adding more water to the machine, slowing down the motor so that the pump does not require as much water to operate, any combination of these actions, or any action that will clean the filter.

When the filter begins to become blocked, the water level at the pump suction falls since water is no longer passing through the filter at a high enough rate to replace the water that the pump draws. When the water level at the pump inlet has fallen to a level where air is drawn into the pump, the pump will begin to lose prime. Upon losing prime, the torque required to operate the pump will drop, which causes the speed of the motor to increase. This loss in torque can be detected by monitoring the power consumption of the motor. The present pump prime sensing system evaluates power consumption information by the motor to determine if the filter has become clogged.

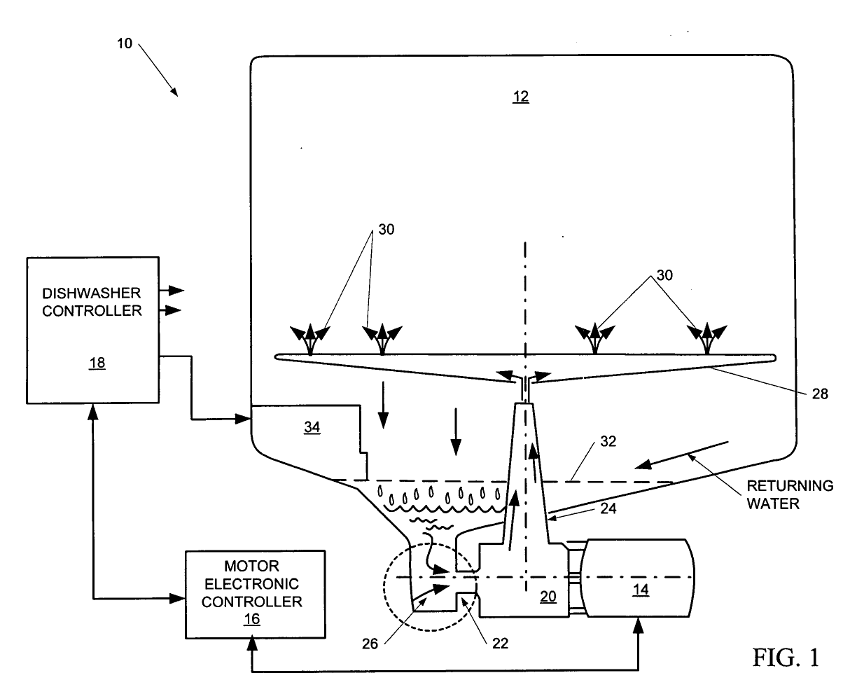

FIG. 1 illustrates a dishwasher 10 that includes a dishwasher tub 12 that is capable of receiving dishes in trays (not shown) and that contains a pump prime sensing system and a filtration system. The present system includes a motor 14 that drives a pump 20. The motor 14 is connected to a motor electronic controller 16, which, in turn, is connected to a dishwasher controller 18. The dishwasher controller is connected to a filter cleaning system 34 to clean the filter.

The pump 20 has a pump suction inlet 22 that receives water from the dishwasher tub. The pump also has a pump discharge 24, which generally is positioned above the pump, and is connected to a spray arm 28. Water from the dishwasher tub 12 is suctioned by the pump 20 through the pump suction inlet 22 and forced through the pump discharge 24 to the spray arm 28. The spray arm 28 then disperses the pumped water into the dishwasher tub 12 through water jets 30. The water jets 30 are disposed along the spray arm 28 and can comprise any number or configuration that allows the pumped water to be dispersed to dishes or other items in the dishwasher tub 12 to remove debris or other food/soil therefrom during dishwasher operation.

Water from the dishwasher tub 12 normally collects towards the bottom of the tub 12 into sump 26 under the force of gravity. The sump 26 is connected to the pump suction inlet 22 to allow water to be communicated from the dishwasher tub 12 into the pump 20. The sump 26 can comprise any form, and, generally, merges with the pump suction inlet 22 to allow a large enough volume of water to proceed there through at a rate dictated by the pump 20. The pump suction inlet 22 typically is arranged above the bottom of the sump 26 to allow the water from the dishwasher tub 12 to be maintained at a height level to enable monitoring of the filtration system. The filtration system generally is monitored by gauging a depth of the water in the sump 26 by the influx of any air received into the pump suction inlet 22 as detailed herein.

The present filtration system includes a filter 32 and a filter cleaning system 34. The filter cleaning system is deactivated in state 1 as shown in FIG. 1. The filter 32 generally is disposed in the dishwasher tub 12 above the sump 26. The filter 32 is a full-flow filter and spans the opening above the sump 26 to filter all water received in the sump 26 through the pump suction inlet 22 into the pump 20. The filter holes in this full-flow filter 32 generally are formed smaller than conventional filters, which are designed for a worst-case soil load. When the present system indicates that the filter 32 has become clogged, the filter cleaning system 34 employs any of several cleaning methods to clean the filter 32.

In operation, FIG. 1 shows the dishwasher 10 in wash mode with a clean filter 32. In state 1 as shown in FIG. 1, enough water from the dishwasher tub 12 passes through the filter 32, the sump 26, the pump suction inlet 22, and the pump 20 to keep up with the pump's demand. The pump 20 is fully primed since only water is being drawn into the pump suction inlet 22.

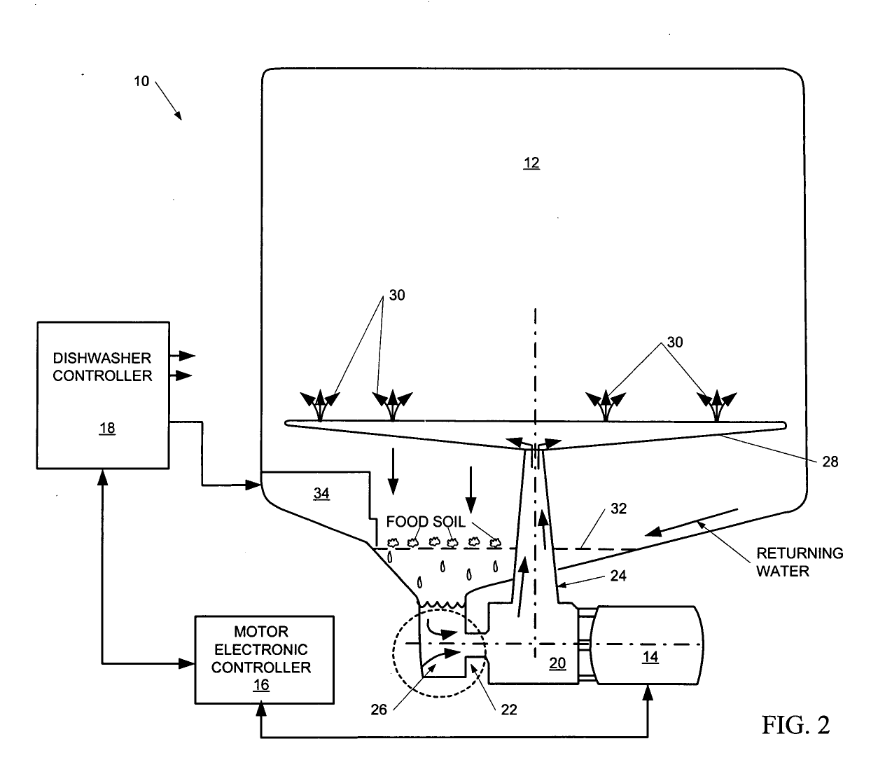

FIG. 2 shows the dishwasher 10, still in wash mode, in state 2, with the filter 32 beginning to clog with food soil or other debris from the dishes in the dishwasher 10. As the food/soil accumulates on the filter 32, the holes of the filter 32 begin to clog. The clogging allows passage of less water through the filter 32, which results in less water reaching both the sump 26 and the pump 20 through the pump suction inlet 22. Thus, the water level in the sump 26 begins to fall as food/soil occludes the holes of the filter 32. The pump 20 continues to operate at full prime at the same rate in state 2, shown in FIG. 2, as state 1, as shown in FIG. 1. The filter cleaning system 34 continues to be deactivated in state 2.

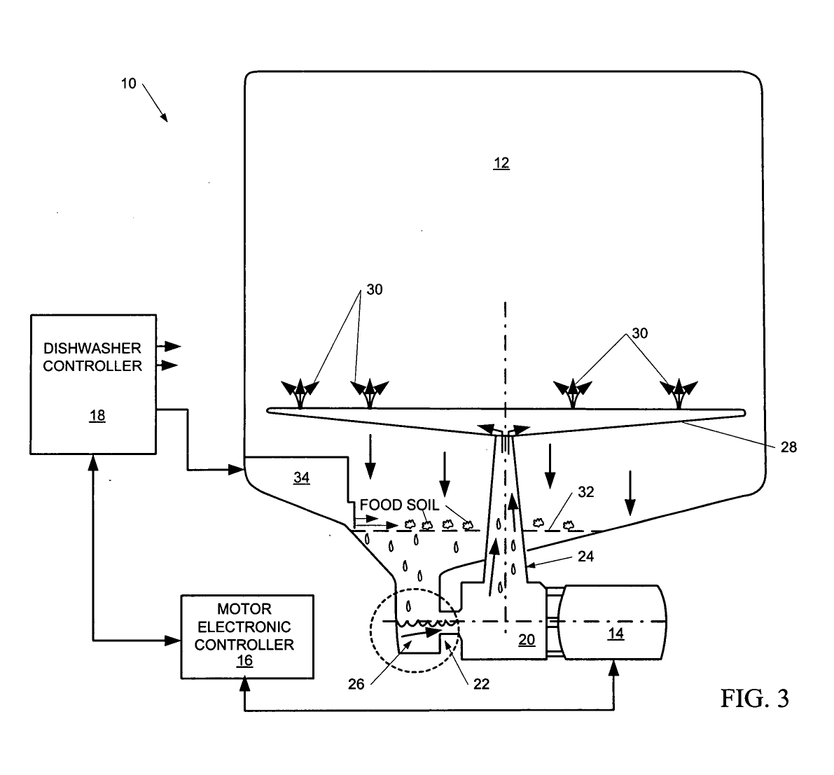

FIG. 3 shows the dishwasher 10 in state 3 with the dishwasher 10 still in wash mode. In FIG. 3, the filter 32 has continued to clog with food/soil from the dishes. The food/soil buildup on the filter 32 has occluded more holes and has allowed less water into the sump 26. The pump 20 continues to operate at the same rate as in states 1 and 2 until a mixture of air and water begins to enter the pump suction inlet 22. The water level in the sump has fallen from the level in states 1 and 2 as shown in FIGS. 1 and 2.

In FIG. 3, the water in the sump has fallen to a level where air enters the pump suction inlet 22 and reaches the pump 20. As the mixture of water and air is drawn into the pump 20, the torque load required for the motor 14 to drive the pump 20 is lowered. The motor controller 16 senses the lower torque requirement of the motor 14 and transmits this torque data to the dishwasher controller 18. The dishwasher controller 18 then activates the filter cleaning system 34 to clean the filter 32. The cleaning of the filter 32 can be performed by any method that will allow the pump to return to full prime, including: pumping the soil-laden wash water out of the dishwasher, adding water to dilute the soil-laden wash water, activating a mechanical filter-cleaning device, e.g. a motor-driven wiper, decreasing the flow rate through the pump while operating only the filter cleaning jets, any combination of these actions, or any other action that will clean the filter. The dishwasher controller 18 generally includes a microprocessor to control the filter cleaning system 34 to clean the filter 32 in the response to signals from the motor electronic controller.

Once the filter 32 has been cleaned, the dishwasher 10 returns to wash mode, operating again in state 1 as shown in FIG. 1. The filter cleaning system 34 has removed the debris from the filter 32 and the pump 20 has returned to full prime since the unclogged filter 32 now allows passage of water at a high enough flow rate to keep up with the flow rate of the pump 20. Thus, due to the cleaning of the filter 32, the water level in the sump 26 raises enough to cover the pump suction inlet 22 and not allow air entry. Since the pump suction inlet 22 is not receiving a mixture of air and water from the sump 26, the pump 20 is drawing only water through the pump suction inlet 22 and the torque required to drive the pump 20 has returned to its regular operating level. The filter cleaning system 34 has been deactivated after the filter has been cleaned. The cleaning of dishes inside the dishwasher 10 continues at an optimum level after the filter has been cleaned and the monitoring cycle described herein continues.

The present system provides an apparatus and method for monitoring or sensing the amount of clogging of a filter in a dishwasher tub. This sensing will save time, energy, and water by not requiring the dishwasher to unnecessarily drain and refill at times when the filter may not be clogged entirely.

While the invention has been disclosed in its preferred forms, it will be apparent to those skilled in the art that many modifications, additions, and deletions can be made therein without departing from the spirit and scope of the invention in its equivalents as set forth in the following claims.

We claim:

1. A dishwasher incorporating a pump prime sensing system for managing a filtration system, the dishwasher comprising:
a motor that controls a pump, the pump operating at a water torque level when the pump receives water that has passed through a filter;
a pump inlet and a pump discharge in communication with the pump;
wherein, when the pump inlet receives a mixture of air and water, the pump operates at a mixture torque level that is lower than the water torque level; and
wherein operation of the pump at the mixture torque level triggers a cleaning of the filter.

2. The dishwasher of claim 1, further comprising a filter cleaning system capable of cleaning the filter.

3. The dishwasher of claim 2, wherein the filter cleaning system cleans the filter by pumping soil-laden wash water out of the dishwasher, by adding water to dilute the soil-laden wash water, by activating a mechanical filter-cleaning device, by decreasing a flow rate through the pump and operating only filter cleaning jets, or by any combination of these actions.

4. The dishwasher of claim 1, wherein the motor is connected to an electronic controller that monitors a load on the motor.

5. The dishwasher of claim 4, wherein the electronic controller is connected to a dishwasher controller and is capable of transmitting motor loading data to the dishwasher controller.

6. The dishwasher of claim 5, wherein the dishwasher controller is connected to a filter cleaning system that cleans the filter.

7. The dishwasher of claim 1, wherein the filter is positioned above the pump inlet.

8. The dishwasher of claim 1, wherein the pump discharge is connected to a spray arm.

9. The dishwasher of claim 8, wherein the spray arm includes at least one wash jet.

10. The dishwasher of claim 1, further comprising a sump disposed below the filter and in communication with the pump inlet.

11. The dishwasher of claim 10, wherein the pump inlet is disposed above the bottom of the sump.

12. A method of operating a dishwasher to clean debris from dishes, the dishwasher incorporating a pump prime sensing system in communication with a filtration system, the method comprising:
drawing water through a filter, then through a pump inlet that is in communication with a pump, the pump operating at a water torque level;
straining the debris, loosed from the dishes, from the water with the filter;
drawing a mixture of air and water through the pump inlet when the filter has become clogged by the debris, which results in operation of the pump at a mixture torque level that is less than the water torque level; and,
cleaning the filter in response to operating the pump at the mixture torque level.

13. The method of claim 12, wherein the cleaning includes:
pumping debris-laden water out of the dishwasher.

14. The method of claim 12, wherein the cleaning includes:
adding water to dilute debris-laden water.

15. The method of claim 12, wherein the cleaning includes:
decreasing a flow rate through the pump and operating only filter cleaning jets.

16. The method of claim 12, wherein the cleaning includes:
activating a mechanical filter-cleaning device.

17. The method of claim 12, wherein the pump is connected to a motor, which is in communication with an electronic controller, and wherein before the step of drawing water through a filter, the method further comprises:
monitoring a torque load on the motor.

18. The method of claim 17, wherein the electronic controller is in communication with a dishwasher controller that is in communication with a filter cleaning system that cleans the filter.

19. The method of claim 12, further comprising:
spraying the water from a spray arm that is connected to a pump discharge in communication with the pump.

20. The method of claim 12, wherein the dishwasher further comprises a sump disposed below the filter in communication with the pump inlet.
